(19) United States
(12) Patent Application Publication
(10) Pub. No.: US 2026/0127667 A1
(43) Pub. Date: May 7, 2026

(54) SYSTEMS AND METHODS FOR PROPORTIONATE ALLOCATION

(71) Applicant: WELLS FARGO BANK, N.A., San Francisco, CA (US)

(72) Inventors: Daphne Beyers, Charlotte, NC (US); Pallavi Kalahasti, Pleasanton, CA (US); Andrew Scott Hanson, Urbandale, IA (US)

(21) Appl. No.: 18/938,166

(22) Filed: Nov. 5, 2024

(51) Int. Cl. G06F 16/23; G06F 11/07; G06Q 40/03

(52) U.S. Cl. CPC G06Q 40/03; G06F 11/0721; G06F 11/0793; G06F 16/2365; G06Q 40/034

(57) ABSTRACT

Systems and methods for proportionate allocation. The systems and methods include generating a pool table including pools. Each of the pools includes a set of records such as a loan identifier, account identifier, investor identifier, pool identifier, and amount identifier. For each of the pools, unallocated values are determined by summing each amount identifier within the pool having a null loan identifier and comparing the unallocated value against a pro rata threshold. If the unallocated value exceeds the pro rata threshold, the method includes generating, for each record, a credit pro rata value and allocating the credit pro rata value to each loan identifier within the pool. Otherwise, if the unallocated value is less than or equal to the pro rata threshold, the method includes generating, for each record, a debit pro rata value and allocating the debit pro rata value to each loan identifier value within the pool.

### FIELD OF INVENTION

The present disclosure generally relates to data enhancement through allocation of values within data tables, and more specifically to systems and methods for the accurate generation of pool tables used to proportionately allocate data within the pool tables.

### BACKGROUND

In managing data records within databases, issues can arise records related to records with unallocated values. Unallocated records can include those records where certain fields identifying a corresponding entity or user are null, while a target value for requiring distribution for proper record keeping is present. Unallocated records can indicate that the target values in other records are inaccurate. Inaccurate values within a database are a central issue within proper database management, particularly where regulatory protocols require assurance of database accuracy. Thus, such records may need to be allocated. Yet, allocating records within a main database can inhibit the performance of that main database by requiring great expenditures in building and maintenance of such a database. Allocating records in the main database can thus reduce the efficiency of the database, yet leaving records unallocated similarly impairs the performance of such databases.

To properly allocate the previously unallocated values, accurately generated data tables may be necessary to ensure that the premises of the allocation are correct. Current techniques for generating data tables used to represent data for allocation lack controls and checks on the data merging and refinement process. As a result, data that is allocated may be allocated incorrectly given the inaccurate data sets forming the basis of the allocation.

### SUMMARY

According to certain examples, a method for proportionate allocation is described. The method includes generating a pool table including one or more pools. Each of the pools includes a set of records such as a loan identifier, account identifier, investor identifier, pool identifier, and amount identifier. For each of the pools, the method includes determining an unallocated value by summing each amount identifier within the pool that has a null loan identifier and comparing the unallocated value against a pro rata threshold. In response to determining the unallocated value exceeds the pro rata threshold, the method includes generating, for each record, a credit pro rata value and allocating the credit pro rata value to each loan identifier within the pool Otherwise, in response to determining the unallocated value is less than or equal to the pro rata threshold, the method includes generating, for each record, a debit pro rata value and allocating the debit pro rata value to each loan identifier value within the pool.

Another example relates to a system including one or more processors configured to generate a pool table including one or more pools. Each of the pools includes a set of records such as a loan identifier, account identifier, investor identifier, pool identifier, and amount identifier. For each of the pools, the processors are configured to determine an unallocated value by summing each amount identifier within the pool that has a null loan identifier and comparing the unallocated value against a pro rata threshold. In response to determining the unallocated value exceeds the pro rata threshold, the processors generate, for each record, a credit pro rata value and allocating the credit pro rata value to each loan identifier within the pool Otherwise, in response to determining the unallocated value is less than or equal to the pro rata threshold, processors generate, for each record, a debit pro rata value and allocating the debit pro rata value to each loan identifier value within the pool.

A further example relates to a non-transitory computer readable medium comprising instructions that, when executed by one or more processors, cause the one or more processors to generate a pool table including one or more pools. Each of the pools includes a set of records such as a loan identifier, account identifier, investor identifier, pool identifier, and amount identifier. For each of the pools, the processors are configured to determine an unallocated value by summing each amount identifier within the pool that has a null loan identifier and comparing the unallocated value against a pro rata threshold. In response to determining the unallocated value exceeds the pro rata threshold, the processors generate, for each record, a credit pro rata value and allocate the credit pro rata value to each loan identifier within the pool Otherwise, in response to determining the unallocated value is less than or equal to the pro rata threshold, processors generate, for each record, a debit pro rata value and allocating the debit pro rata value to each loan identifier value within the pool.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

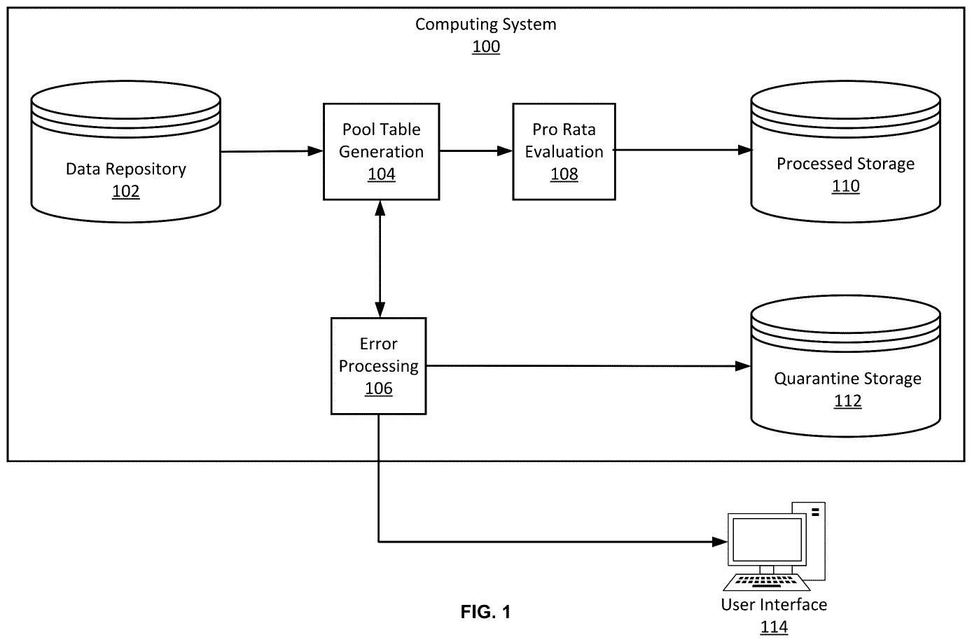

FIG. 1 shows a system for generating pool tables and implementing proportionate allocation, according to certain embodiments.

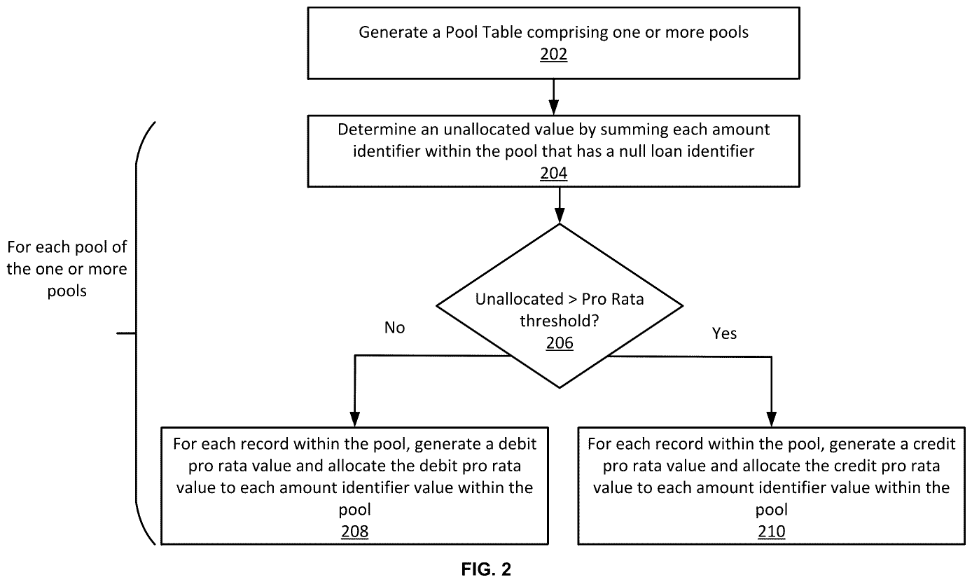

FIG. 2 shows an example process for proportionately allocating values, according to certain embodiments.

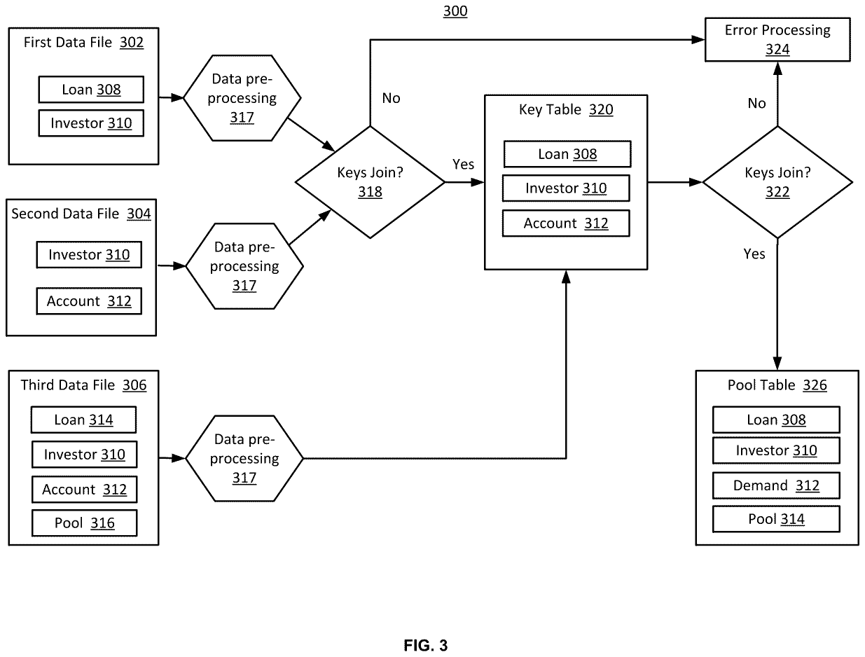

FIG. 3 shows an example process generating pool tables, according to certain embodiments.

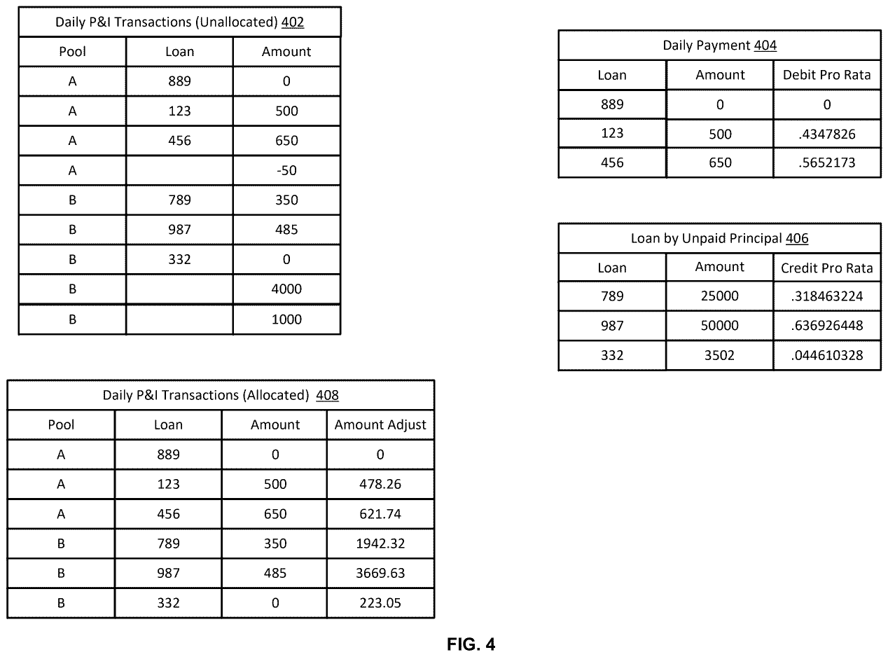

FIG. 4 shows examples of pool tables and modifications made to the pool tables in order to proportionately allocate values, according to certain embodiments.

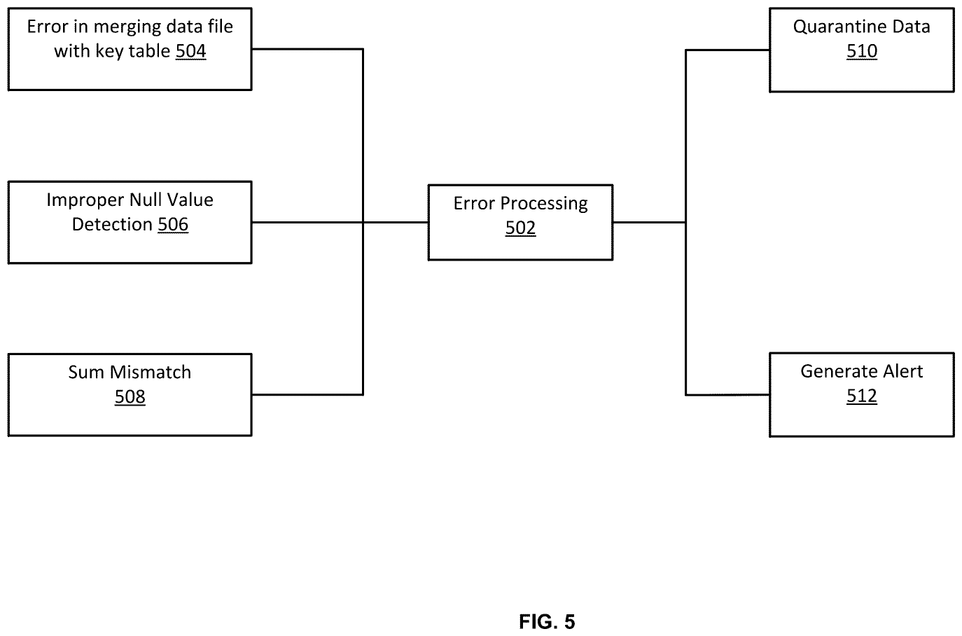

FIG. 5 shows an example of error processing procedures configured to prevent processing of inaccurate data while generating pool tables, according to certain embodiments.

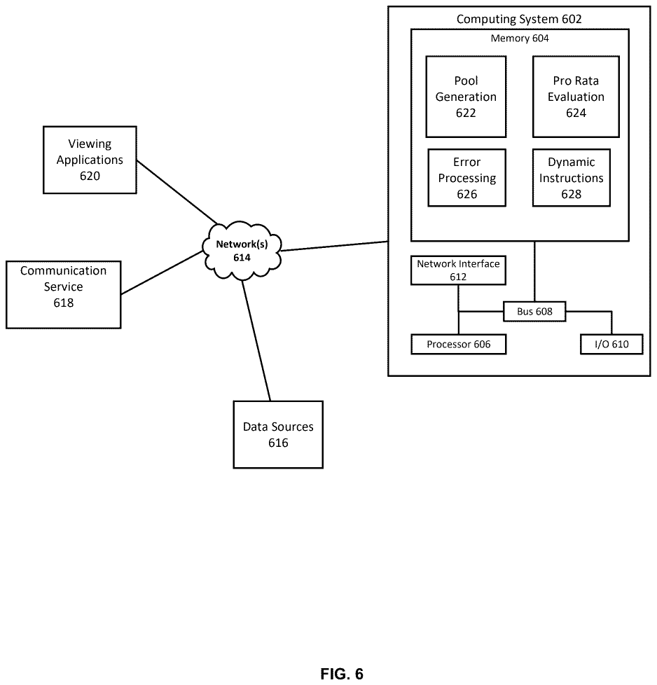

FIG. 6 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of Proportional Allocation

In one illustrative example, a proportional allocation system is described, providing means for identifying unallocated values within a set of records for accurate, fair allocation across a larger set of records within a pool. The proportional allocation system can receive sets of unique data files, each set of data files containing identifiers, or values, that may be used either for assigning the records to a pool or for value assignment and allocation across the records within each assigned pool. Once pool tables are generated, the proportional allocation system can identify records within each pool which include values that are unallocated, requiring assignment and allocation across the sets of records within the pool. The proportional allocation system can sum the unallocated values within the pool and determine whether the sum of the unallocated values exceeds a pro rata threshold. Depending on whether the sum of the unallocated values exceeds the threshold, a credit pro rata value or debit pro rata value may be generated for allocating across the records within the pool.

The proportional allocation system begins with a data preparation stage where data is received from a data repository. The data received is used to generate the pools which may be identified as requiring allocation of given identifiers or amounts within each pool. In one example, generating the pools can include summing principal and interest (“P&I”) daily transactions by loan and by pool. Building the pool table can include building credit and debit pro rata tables, wherein the debt and credit pro rata tables may be used to determine the credit pro rata value and debit pro rata values for each record in the pool which may be assigned per a pro rata decision. For some pools, no unallocated amounts may be identified (e.g., each record within the pool has a loan identifier or other identifier which has already assigned the value otherwise requiring allocation). In such cases, pools with fully allocated amounts may be finalized requiring no further processing. However, some pools may be identified as having unallocated amounts (e.g., records within the pool may be identified has having a non-null amount identifier, while having a null loan identifier). In such cases, the proportional allocation system sends the pools with unallocated amounts to a pro rata decision.

Data preparation, in the form of pool generation, may be augmented by an error processing module, where the error processing module is implemented to ensure the accurate generation of pool tables for further allocation by the pro rata decision and allocation procedure. The error processing module can monitor data received by data repository used for data generation, in addition to monitoring the data at each stage of data transformation during the generation of pool tables. The error processing module, upon identification of one or more risks, failures, or other anomalies, can cause the proportional allocation system to enter a quarantine state, generate alerts, and ensure data reconciliation prior to subsequent processing. The error processing module thus can provide improved techniques for error checking prior to and during several data transmissions.

The pro rata decision can include a process for determining how to properly allocate the unallocated values for a given pool. For each pool with unallocated values, the pro rata decision can sum the unallocated amount (e.g., the amount identifier for each record having a null loan identifier) for each record within the pool. The summed unallocated amount may be compared against a pro rata threshold. In response to the summed unallocated amount exceeding or not exceeding the pro rata threshold, the pro rata decision will determine whether to apply a debit pro rata value or a credit pro rata value per an allocation procedure.

The allocation procedure may include determining, for each record within a pool, a credit pro rata value, or a debit pro rata value for proportionately allocating across the records within the pool. In some instances, the credit pro rata value and the debit pro rata value may be determined for each record within a pool prior to the pro rata decision, where the pro rata decision may then determine whether to assign the credit pro rata value or the debit pro rata value to the records within the pool. The credit pro rata value may be determined based on slower velocity data as data stored within the generated pool tables. For instance, the credit pro rata can be determined based on a loan by unpaid principal (“LUP”) value for a given record compared against the sum of LUP values within the pool. The debit pro rata may be similarly determined, wherein the debit pro rata value is based on higher velocity data stored within the generated pool tables. In some examples, the debit pro rata can be determined based on a daily transaction value for a given record compared against the sum of daily transactions for each record within the pool.

### Example Computing System for Proportional Allocation

FIG. 1 illustrates a system for generating pool tables and implementing proportionate allocation, according to certain embodiments. The embodiments according to FIG. 1 are shown to illustrate the logical and physical implementation of the proportional allocation system according to certain embodiments. Other embodiments, however, are possible. For instance, certain components may be shown as distinct components to illustrate the progression of the data flow, while according to some embodiments, the physical implementation of such components may be implemented across the same device. It is to be appreciated that the example embodiments according to FIG. 1 are provided for illustrative purposes. A computing system 100 is shown for generating the pool tables and performing pro rata evaluation in furtherance of proportionally allocating values received from a data repository 102. Examples of implementations of the computing system 100 capable of implementing the described embodiments of FIG. 1 are discussed further with respect to the computing system of FIG. 6.

The computing system 100 shows a pool table generation component receiving data from a data repository 102. The data repository 102 can comprise one or more databases for storing files and records necessary for pool table generation and pro rata evaluation. The data repository can comprise a distributed file system (e.g., a cloud-based storage system), or one or more databases local to a fixed computing environment. Files and records stored in the data repository 102, for instance, can comprise various files and records for allocation and to supplement allocation. In one example, a first data file or set of data files can comprise a set of records indicating loans by unpaid principal (“LUP”); a second data file or set of data files can comprise a cross-reference file linking demand deposit accounts (“DDAs”) to investors; and a third data file or set of data files can comprise records indicating daily P&I transactions.

A pool table generation module 104 is shown receiving data files and records from the data repository 102. Described further with respect to FIG. 3, the pool table generation module 104 is able to identify linking information between records and data files within the data repository 102 to generate pool tables necessary to perform pro-rata evaluation per module 108. The pool table generation module 104 is also communicatively coupled to an error processing module 106 so as to automatically detect corrupted files within the data repository 102 and other errors while the pool table generation module 104 is operating. Error processing 106 can further cause the computing system 100 to enter a quarantine state and prevent the further processing, transmission and storage of faulty, incorrect data as received in the data repository 102 or as generated by the pool table generation module 104.

Additionally or alternatively, the error processing module 106 can store any corrupted files or pool tables identified as incomplete or otherwise incorrect for storage in a quarantine storage repository 112. The quarantine storage repository 112 can store data for later auditing, debugging, and analysis. The quarantine storage repository 112 can be located in the same physical storage system as the data repository 102 or may be stored in another physical storage system divorced from the data repository 102. The quarantine storage repository 112 may provide for storage of data files and records for subsequent by a user through a user interface 114. In some examples, the error processing module 106, upon detection of an error prevents the transmission of the generated pool table to the pro rata evaluation module 108 and/or the processed storage repository 110 and instead transmits the generated pool table to quarantine storage 112 and additionally generates an alert through the user interface 114 indicating that the generated pool table contains one or more identified errors to be reviewed in the quarantine storage repository 112. Further operations of the error processing module 106 are described with respect to FIG. 5.

Subsequent to operations performed by the pool table generation module 104, a pro rata evaluation module 108 is able proportionately allocate values, such as loan records within each pool in the generated pool table. The pro rata evaluation module 108 may also identify records with null values such as null loan identifiers. The associated records can then be identified as being unallocated, lacking a loan identifier to assign values to. The pro-rata evaluation module in response determines, for each pool with an unallocated value, whether to apply a credit pro rata value or a debit pro rata value by comparing the sum unallocated amount within each pool against a threshold. Further description of the procedure for proportional allocation via the pro rata evaluation module is provided with respect to FIG. 3.

The pro rata evaluation module 108, subsequent to proportionately allocating values within the one or more pools, can store the updated pools in a processed storage repository 110. In some examples, the data repository 102 and the processed storage repository 110 may comprise the same physical storage locations. In the same or other examples, the pro rata evaluation module 108 can transmit the updated pool tables across one or more networks to processed storage repository for subsequent retrieval and evaluation through a user interface 114.

### Example Process for Proportional Allocation

FIG. 2 shows an example process for proportionately allocating values, according to certain embodiments. For illustrative purposes, the process 200 is described with reference to implementations described above with respect to one or more examples described herein. Other implementations, however, are possible. In some aspects, the operations in FIG. 2 may be implemented in program code that is executed by one or more computing devices such as the computing system 100 of FIG. 1. In some aspects of the present disclosure, one or more operations shown in FIG. 2 may be omitted or performed in a different order. Similarly, additional operations not shown in FIG. 2 may be performed.

At block 202 the process 200 involves generating a pool table comprising one or more pools. The process for generating the pool table is described further with respect to FIGS. 3-4. Each pool comprises a set of data records grouped together based on a shared characteristics represented by one or more identifiers. For instance, a pool may refer to a set of data records identified as belonging to a given user or entity. Each pool may relate to a set of users or entities, for instance, a subset of users or entities identified as having performed an action or transaction on a given day. Any variation of pooling may be performed, but generally pools will be formed on the basis of properly allocating a target asset or value across the pool.

Each record for pooling can contain an array of identifiers. Any permutation of identifiers may be used to generate the pool grouping. For instance, a single identifier such as an entity identifier can form the basis for pooling the data records. In another example, a location identifier and a time identifier may be used in conjunction to determine the pooling. In one example, each record contains a loan identifier, account identifier, investor identifier, pool identifier, and amount identifier. Other identifiers may be used for allocation across records within the pool.

One or more identifiers within each record may be a target asset for allocation. The target asset may be a value that requires accurate allocation across the pool, such as an amount to be distributed across the pool in one form or another. In one illustrative example, the target asset is an amount identifier comprising principal and interest (“P&I”) payments. Such P&I payments may typically be required to be allocated accurately to each set of records, corresponding to entities or customers, within the pool. However, due to how data may be received and stored in the data repository 102, such values may not initially be allocated at the entity level. Particularly where a given record contains a P&I payment but no corresponding identifiers linking to an entity, precise allocation techniques, described further with respect to blocks 204-212, may support the accurate allocation of such P&I values, among any other value requiring proportional allocation.

Blocks 204-212 are shown as being iteratively performed for each pool of the one or more pools as generated for the pool table per block 202. In other examples, only a single pool may be evaluated per blocks 204-210 or a subset of the pools as contained within the generated pool table per block 202 may be evaluated per blocks 204-210.

At block 204, the process 200 involves determining an unallocated value by summing each amount identifier within the pool that has a null loan identifier. Generally, the loan identifier may comprise an identifier representative of an entity such as a person, business, or the like. Allocation of loans and other values may depend on the proper identification of the entity as provided in the loan identifier. Otherwise, records lacking a loan identifier value but still containing an amount identifier value are referred to as unallocated records, wherein the amount identifiers of the unallocated records are unallocated and required to be dispersed amongst the allocated records within the pool. The pro rata evaluation module 108 can identify each of the records within the pool which lacks the loan identifier and summing its corresponding amount identifier value with the remaining records to determine the unallocated value.

At block 206, the process 200 involves comparing the unallocated value against a pro rata threshold. Generally, the pro rata threshold may have a value of zero, such that the unallocated value is evaluated as being either a negative value or a positive value. The unallocated values being under the threshold (e.g., negative) may cause the process to proceed to block 208 where a debit pro rata value is determined, while those unallocated values exceeding the threshold (e.g., positive) may cause the process to proceed to block 210 where a credit pro rata value is determined.

At block 208, in response to determining the unallocated value is under the pro rata threshold, the process 200 involves, for each record within the pool, generating a debit pro rata value, and allocating the debit pro rata value to each loan identifier within the pool. The debit pro rata can comprise any value distinguishable from the credit pro rata value discussed with respect to block 210 and used to allocate a debit pro rata value to loan identifiers within the pool. In one illustrative example, the debit pro rata value is determined by retrieving a daily payment value for each record within the pool, summing the daily payment value for all records within the pool to generate a pool daily payment value sum, and for each record, dividing the record's daily payment value by the pool daily payment value sum to generate the record's debit pro rata value. The debit pro rata value can then be allocated to each amount identifier value within the pool. Allocating the debit pro rata value can comprise applying the debit pro rata value for each record to the unallocated value as determined at block 204 and distributing the product of the debit pro rata and the unallocated value to each record's amount identifier.

At block 210, in response to determining the unallocated value is greater than the pro rata threshold, the process 200 involves, for each record within the pool, generating a credit pro rata value, and allocating the credit pro rata value to each loan identifier within the pool. The credit pro rata can comprise any value distinguishable from the debit pro rata value discussed with respect to block 208 and used to allocate a credit pro rata value to loan identifiers within the pool. In one illustrative example, the credit pro rata value is determined by retrieving an unpaid principal value for each record within the pool, summing the unpaid principal value for all records within the pool to generate a pool unpaid principal value sum, and for each record, dividing the record's unpaid principal value by the pool unpaid principal value sum to generate the record's credit pro rata value. The credit pro rata value can then be allocated to each amount identifier value within the pool. Allocating the credit pro rata value can comprise applying the credit pro rata value for each record to the unallocated value as determined at block 204 and distributing the product of the credit pro rata and the unallocated value to each record's amount identifier.

In some examples, process 200 can occur external to the data repository 102 (e.g., a main database storing allocated and unallocated records accessed by other components of a computing system). Rather, the process 200 of proportionately allocating values can occur external to the data repository 102, and the allocated records can be stored in a second database such as processed storage 110 wherein processed storage comprises a separate database from data repository 102. By divorcing process 200 from the data repository 102, the described procedures (including those further described in FIGS. 3-5), which may otherwise burden network bandwidth and accessibility of the data repository 102, may more efficiently be performed with respect to processed storage 110. Such a separation can improve the accuracy of data by allocating the records within the processed storage 110, while not reducing efficiency of the data repository 102. Moreover, divorcing the data repository 102 from process 200 and processed storage 110 can reduce the complexity of maintaining the data repository 102, which may be critical for other tasks, by providing the processed storage 110 as a separate database and service for allocated record maintenance and/or retrieval.

### Example Process for Generating Pool Tables for Proportional Allocation

FIG. 3 shows an example process for generating pool tables, according to certain embodiments. For illustrative purposes, the process 300 is described with reference to implementations described above with respect to one or more examples described herein. Other implementations, however, are possible. In some aspects, the operations in FIG. 3 may be implemented in program code that is executed by one or more computing devices such as the computing system 100 of FIG. 1. In some aspects of the present disclosure, one or more operations shown in FIG. 3 may be omitted or performed in a different order. Similarly, additional operations not shown in FIG. 3 may be performed.

First data file 302 is shown as one input (e.g., as received from data repository 102), to the pool generation module. The first data file 302 is shown including first loan data 308 and investor identifier value 310. As an example, the first loan data 308 can comprise a loan identifier value and an unpaid principal value associated with the loan. Thus, in certain examples, the first data file may comprise a set of records each including a LUP value.

Second data file 304 is shown as another input to the pool generation module. The second data file 304 is shown including an investor identifier value 310 and an account identifier value 312. The investor identifier value 310 of the second data file 304 is shown as similar to the investor identifier 310 of the first data file 302 and may be used to join the first data file 302 with the second data file 304 per subsequent operations at block 318. The account identifier 312 may refer to a demand deposit account (“DDA”) or any other identifier of a user or entity account.

Third data file 306 is shown including third loan data 314, investor identifier 310, an account identifier 312, and a pool identifier 316. The third loan data can comprise a loan identifier value and a daily payment value associated with the loan. The third data file may also be referred to as the daily principal & interest transactions file (“DPI”). While shown as including an investor identifier 310 and an account identifier 312, in some examples, the DPI file may contain the investor identifier 310, or the account identifier 312, but not both, for a given record. In instances where neither value is present for a given record, the lack of investor identifier 310 and account identifier 312 may cause the error processing module 106 to enter a quarantine state or generate alerts to allow for data reconciliation prior to the pro rata evaluation module 108 determining methods of allocating values across records within a pool.

Each of the data files 302, 304, 306 may be pre-processed per data preprocessing procedures at blocks 317. Data pre-processing can include data normalization, formatting, and cleaning of the data as received by the data files for subsequent processing and key table generation. For instance, the investor identifier 310 in the first data file 302 may be a string value, while the investor identifier 310 of the second data file 304 may be an integer value. The data pre-processing procedures 317 can convert each of the identifiers 308-316 into standardized data formats for ease of comparison and linking between the data sets. For some identifiers, such as amount identifiers, null values may be formatted as zero-values, while for other identifiers, such as loan identifiers, null values may be formatted as “null”.

Subsequent to the data pre-processing procedures of blocks 317, the first data file 302 and the second data file 304 may be joined per block 318 to form a key table 320. In some instances, the pool table generation module will be unable to join the first data file 302 and the second data file 304. For instance, if investor identifiers 310 do not match, such errors during data pre-processing 317 may prevent the transmission of the first data file 302 or the second data file 304 for joining per block 318. In response to being unable to join the first data file 302 and the second data file 304, the pool generation module may transmit the first data file 302 and the second data file 304, and/or the key table generated despite lacking necessary information to error processing 324.

If errors are otherwise not detected, and the first data file 302 and second data file 304 are able to join keys, the process may proceed to generating the key table 320. The key table 320 is shown including loan data 308, an investor identifier 310, and an account identifier 312. The key table 320 represents the merged, normalized data from received data files 302 and 304.

Provided the key table 320 is able to be generated without errors, a similar process may be applied to join the key table 320 with the third data file 306 subsequent to the third data file 306 being normalized per data pre-processing 317. The normalized third data file may comprise loan identifiers 314, pool identifiers 316, and one or both of investor identifiers 310 and account identifiers 312. In the event the normalized third data file lacks both an investor identifier 310 and an account identifier 312, the keys mail fail to join at block 322 and the process 300 may return to error processing 324. In the event of no identified errors, the key table 320 may be further combined with the normalized, third data file 306 to form the pool table 326.

The pool table 326, as shown in the example of FIG. 3, includes loan identifier, investor identifier 310, account identifier 312, and pool identifier 316. Each of these identifiers may be stored for each set of records as stored in the pool table 326. The pool table 326 may thus represent a set of records grouped together by one or more identifiers, and including an identifier (e.g., the amount identifier), for allocation per the pro rata evaluation module 108. The pool table 326 according to other examples may otherwise include records with other identifiers but will generally include records where each record includes identifiers for assigning the record to the pool, and an identifier value for allocation by the pro rata evaluation module 108.

FIG. 4 illustrates examples of different dimensions of a simplified pool table and modifications made to the pool table in order to proportionately allocate values, according to certain embodiments. For instance, each of tables 402 and 408 show daily P&I transactions associated with a set of loan identifiers for pools A and B, with table 402 showing the unallocated amounts, and table 408 showing the tables being allocated with debit and credit pro rata values, respectively. Tables 404 and 406 show examples of how credit and debit pro rata values may be calculated prior to allocating per table 408.

Table 402 shows a set of loans, identified per their loan identifiers, and each with an associated amount identifier value. The loans are shown as grouped into Pools A and B. In the simplified example of FIG. 4, only these two pools are shown, but it is to be appreciated that any number of pools, each comprising any number of records may form a pool table. Moreover, pools may be generated based on any classification of shared characteristics between records.

Each of pools A and B of table 402 are shown as including unallocated records (e.g., lacking a loan identifier value). Specifically, pool A is shown as having a value of −50 as unallocated, while pool B is shown as having two values of 4000 and 1000 as unallocated. When multiple unallocated values are present in a pool, as in pool B, the unallocated values may be summed to generate an aggregate unallocated value within the respective pool. Each of the pools with an unallocated value may then be identified per the pro rata evaluation module 108 for proportional allocation as discussed with respect to FIG. 2, wherein the unallocated value is compared against a pro rata threshold for determination of whether to apply a credit pro rata value or a debit pro rata value. In the example case of FIG. 4, the pro rata threshold is zero, such that the pool A would be allocated by the debit pro rata while pool B would be allocated by the credit pro rata.

Table 404 shows another view of the pool table including the allocated records of pool A's identifiers, daily payment value, and calculated debit pro rata. Such values are shown as an example of the values which may be used to generate the credit pro rata value for a set of records within a pool identified as falling under the pro rata threshold. To generate the debit pro rata threshold, the pro rata evaluation module can retrieve the daily payment values for each record within the pool. The debit pro rata value for a given record within pool A may then be the daily payment value of the given record, divided by the sum of the daily payment values for each record within the pool. In table 404, the debit pro rata for loan 123 is shown as 0.4347826 or 500/1150, and similarly for loan 456, the value debit pro rata is shown as 0.5652173 or 650/1150. A benefit of calculating the debit pro rata value in such a way as that it may provide for greater proportional fairness when allocating the unallocated amount within a pool across the remaining records in the pool. Unlike application of the credit pro rata in such cases, the unallocated loan will be proportionately allocated based on daily payment records, such that debit values are more accurately, fairly allocated across records at a daily transaction level. The debit pro rata avoids allocating debts and other negative amounts determined likely to have been current on payments (e.g., based on patterns identified within the allocated P&I transactions table 408) and thus undeserving of further allocation of such negative amounts.

Table 406 shows another view of the pool table including the allocated records of pool B's identifiers, unpaid principal value, and calculated credit pro rata. Such values are shown as an example of the values which may be used to generate the credit pro rata value for a set of records within a pool identified as exceeding the pro rata threshold. To generate the credit pro rata threshold, the pro rata evaluation module can retrieve the unpaid principal values for each record within the pool. The credit pro rata value for a given record within pool B may then be the unpaid principal value of the given record, divided by the sum of the unpaid principal values for each record within the pool. In table 406, the credit pro rata for loan 789 is shown as 0.318463224 or 25000/78502, and similarly for loan 987, the value debit pro rata is shown as 0.636926448 or 50000/78502. A benefit of calculating the credit pro rata value in such a way as that it may provide for greater proportional fairness when allocating the unallocated amount within a pool across the remaining records in the pool. Unlike application of the debit pro rata in such cases, the unallocated loan is allocated based on the unpaid principal, or other data file with a slower moving data velocity. In such a way, the credit pro rata allocation avoids excessively high allocations based on higher velocity data such as daily level transactions and instead can more evenly distribute the unallocated amount across pool table. As an example, if the value to be allocated is money, the credit pro rata would more evenly distribute the unallocated amount based on unpaid principal, rather than based on which users within the database happened to be paying on a given day.

Table 408 shows another view of the pool table showing the unallocated values being allocated to the remaining records within the pool via application of the debit and credit pro rata. Records within the pool A are shown adjusted by the debit pro rata, while records within the pool B are shown adjusted by the credit pro rata. The debit pro rata is shown allocated to amount identifier by, for each record, taking the product of the debit pro and the unallocated amount (−50) per table 402, and applying the sum to the previous amount identifier value. Thus, allocating the debit pro rata for loan identifier 123 of pool A would comprise adding the product of the debit pro rata value for record 123 (0.4347826) and the unallocated amount within the pool (−50) to generate the adjusted amount value of 478.26 for loan identifier 123, as shown in the example of FIG. 4. A similar process of credit pro rata allocation would entail adding the product of the credit pro rata value for a given record (e.g., 0.318463224 for loan identifier 789) and the unallocated amount within the pool (5000 for pool B) to generate the adjusted amount of 1942.32 for loan identifier 789.

### Example Process for Error Processing During Pool Table Generation

FIG. 5 shows an example of error processing procedures configured to prevent processing of inaccurate data while generating pool tables, according to certain embodiments. The error processing module 502 (similar to error processing modules 106, 324) is shown capable of identifying several inputs 504-508, and in response automatically executing one or more of actions 510-512 to resolve the errors. The error processing module 502 as described at least in the examples of FIG. 5, can thus provide for improvements in the fields of data management through providing necessary checks to data preparation (e.g., as in the preparation of the pool table per FIG. 3), in order to prevent the generation of inaccurate data which may cause disruptions within data repositories and databases.

Inputs 504-508 to the error processing module 502 are non-exhaustive and instead provide for examples of different ways in which the error processing module 502 can identify issues in pool table generation so as to react and prevent the storage and transmission of inaccurate data in one or more data repositories (e.g., the processed storage repository 110 of FIG. 1).

As a first example 504 of an input for error processing, the error processing module 502 can monitor the pool table generation module 104 to identify issues in merging and generating the key table. For example errors in merging data files to form the key table may result from inability to access a given data file (e.g., the file is unable to be located, has restricted access permission, or the data repository storing the data is inaccessible), the file is corrupted, or the file is missing essential information for merging.

As a second example 506 of an input for error processing, the error processing module 502 can monitor the pool table generation module 104 to identify improper null values within the data files for merging. Null values may be initially detected during pool table generation while undergoing the data pre-processing 317, for instance, when data is cleaned and formatted for subsequent merging. While some identifiers may not impact pool table generation and are to be expected (e.g., in the case of null loan identifier values indicating a record requiring allocation). Other null identifiers, or combinations of null identifiers may be identified as improper and inhibiting the proper allocation of values within a pool table. For instance, when data pre-processing the third data file 306, error processing module 502 can detect that a pool identifier 316 and investor identifier 310 are null for a given record with a set of records. Such identifiers may be necessary for joining records of the third data file 306 to the key table 320 to form the pool table 326. In response, the error processing module 502 can enter a quarantine state wherein records unable to be allocated (for instance, due to failure to merge data files) may be stored separately in a quarantine file, while records still able to be processed and allocated continue further processing and transmission.

As a third example 508 of an input for error processing, the error processing module 502 can monitor the pool table generation module 104 to determine a sum mismatch between identifiers within a set of files (e.g., sum values such as loan amounts tied to entities from the first data file 302 and third data file) compared against the loan amounts as stored in the key table 320 or pool table 326. Determining that a given identifier value, such as a loan amount, mismatches between a pool of records from the input files and the generated key table 320 or output pool table 326 may cause the error processing to produce one or more of outputs 510-512 while entering a quarantine state such that the mismatch can be reconciled prior to further processing and allocation, such as by the pro rata evaluation module 108.

Outputs 510-512 of the error processing module 502 illustrate examples of means by which the error processing module 502 can provide improved interfaces and techniques for ensuring accurate generation of pool tables prior to proportional allocation. As with inputs 504-508, the outputs 510-512 are non-exhaustive and instead provide for examples by which the error processing module 502 can react to detected errors and issues during pool table generation. Each of outputs 510-512 may be performed alone or in some combination with other outputs to facilitate automatic and/or manual remediation of detected errors.

Output 510 describes how the error processing module 502 may be configured to enter a quarantine state wherein the error processing module 502 quarantines the data detected during the pool table generation process. Quarantining data can comprise storing the identified data within one or more repositories including a quarantine storage 112. Quarantined data may be kept separate from data within the processed storage 110 such that inaccurately generated pool tables, detected by the error processing module 502, may not be processed per the pro rata evaluation module 108 per FIG. 1. Quarantined data 510 may also be kept for auditing and data assurance purposes. Quarantined data can also include records unable to be allocated or otherwise identified as inaccurate, as identified during the pool generation and record allocation processes. Records able to be allocated and otherwise not identified as inaccurate may continue to be processed.

Output 512 describes how the error processing module 502 may be configured to generate an alert. Alerts may be generated in response to each type of detected input error 504-508. For instance, an alert, displayed through a user interface, may indicate that generation of a pool table failed due to an inability to retrieve a corresponding file, an identified miscalculation, threshold data exceeded, or the like. Alerts can be coupled with other types of error processing output 502. For instance, in one illustrative example, the error processing module 502 detects that two data files are unable to be merged to form a key table per input 504. In response, the error processing module 502 quarantines the data files that are unable to be merged, enters a quarantine state and generates an alert displayed via a user interface indicating the reasons for which the error processing module has entered the quarantine state. The pool table generation module 104 may be configured to resume processing of the data by manual approval received via the interface.

### Example Computing Environment for Proportional Allocation

Any suitable computing system or group of computing systems can be used for performing the operations described herein. For example, FIG. 6 shows a block diagram for an example computing environment capable of executing the described systems and methods, according to certain examples.

The depicted example of a computing system 602 includes one or more processors 606 communicatively coupled to one or more memory devices 604. The processor 606 executes computer-executable program code or accesses information stored in the memory device 604. Examples of processor 606 include a microprocessor, an application-specific integrated circuit (“ASIC”), a field-programmable gate array (“FPGA”), or other suitable processing device. The processor 606 can include any number of processing devices, including one.

The memory device 604 includes any suitable non-transitory computer readable medium for storing pool generation 622, pro rata evaluation, 624, error processing 626, and other dynamic instructions 628 or received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 602 may also include a number of external or internal devices such as input or output devices. For example, the computing system 602 is shown with an input/output (“I/O”) interface 608 that can receive input from input devices or provide output to output devices. A bus 608 can also be included in the computing system 602. The bus 608 can communicatively couple one or more components of the computing system 602.

The computing system 602 executes program code that configures the processor 606 to perform one or more of the operations described above with respect to FIGS. 1-5. The program code includes operations related to, for example, receiving and ingesting data files, generating metadata associated with the data files, and determining access to the data files, or other suitable applications or memory structures that perform one or more operations described herein. The program code may be resident in the memory device 604 or any suitable non-transitory computer-readable medium and may be executed by the processor 606 or any other suitable processor. In some embodiments, the program code described above, including pool generation 622, pro rata evaluation, 624, error processing 626, and other dynamic objects 628 or received or determined values or data objects are stored in the memory device 604, as depicted in FIG. 6. In additional or alternative embodiments, one or more of the pool generation 622, pro rata evaluation, 624, error processing 626, and other dynamic objects 628 or received or determined values or data objects described above are stored in one or more memory devices accessible via a data network, such as a memory device accessible via a cloud service.

The computing system 602 depicted in FIG. 6 also includes at least one network interface 612. The network interface 612 includes any device or group of devices suitable for establishing a wired or wireless data connection to one or more data networks 614 such as viewing applications 620 including user interfaces. Non-limiting examples of the network interface 612 include an Ethernet network adapter, a modem, and/or the like. A remote communication service 618 is connected to the computing system 602 via network 614 and can perform some of the operations described herein including generating templates or receiving messaging data and applying the messaging data to a specified template. The computing system 602 is able to communicate with one or more of the remote communication service 618 and data sources 616. Data sources 616 can include data repository 102, for instance, in examples where the computing system 602 performs the processes of pool generation 622, pro rata evaluation 624, and error processing 626 external to the data repository 102. Data sources can also include processed storage 110, wherein upon completion of the described allocation procedures, data is subsequently transmitted across the network(s) 614 for storage in a separate data repository 102. In other examples, one or more of the data repository 102 and/or processed storage repository 110 can be stored within the computing system 602 such that transmission across network 614 is not necessary.

### Advantages of Systems and Methods for a Proportional Allocation System

The described systems and methods provide improvements to value allocation across values in databases by providing new techniques for the precise, proportionate allocation of identified unallocated values within data sets. The system can first detect unallocated values requiring distribution across a set of records. Then, based on other identifiers within the records, the system can then determine the precise means to distribute the unallocated values across the records. Distributing the unallocated values per nuanced pro rata decisions improves the accuracy of data retained in repositories and can ensure compliance with protocols and regulations requiring the accurate record keeping of data values within database systems.

The described systems and methods additionally provide improvements in accurate allocation of data and storage in corresponding databases by preventing the generation, storage, and transmission of inaccurately apportioned data generated by value allocation systems. Specifically, the described systems and methods provide improved techniques for error checking prior to and during several data transmissions. For instance, an error processing module is described which is capable of monitoring the generation of pool tables used in the proportional allocation of values across the pool. The error processing module can be configured to evaluate data transmissions across multiple stages, improving the ability to detect systematic errors in data reception and transmission. The detection of errors in merging data files to form the key table and pool table, null values, and sum mismatch between identifiers within a set of files can cause the system to enter a quarantine state and automatically flag such input data as inoperative or otherwise inaccurate and prevent further data generation and allocation based on the inaccurate data from being stored in external databases.

Additionally, by providing a separate service for pool generation and separate, processed storage of allocated values external to the data repository, the described techniques provide for improved data accuracy of allocated values within the processed storage repository without limiting the bandwidth and functionality of the data repository. As the data repository can be linked to a larger computing network with components accessing the data repository, providing a technique for improving the accuracy of data accessed from the data repository, while preventing the data repository from being further burdened provides a further technical benefit to database management.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising
generating a pool table comprising one or more pools each comprising a set of records comprising a loan identifier, account identifier, investor identifier, pool identifier, and amount identifier;
for each pool of the one or more pools:
determining an unallocated value by summing each amount identifier within the pool that has a null loan identifier;
comparing the unallocated value against a pro rata threshold,
in response to determining the unallocated value exceeds the pro rata threshold, for each record, generating a credit pro rata value and allocating the credit pro rata value to each amount identifier within the pool; and
in response to determining the unallocated value is less than or equal to the pro rata threshold, for each record, generating a debit pro rata value and allocating the debit pro rata value to each amount identifier value within the pool.

2. The method of claim 1, wherein each record of the set of records further comprises an unpaid principal value, and wherein generating the credit pro rata value for each record comprises dividing unpaid principal value of the record by the sum of the unpaid principal values of all records within the pool.

3. The method of claim 1, wherein each record of the set of records further comprises a daily payment value, and wherein generating the debit pro rata value for each record comprises dividing the daily payment value of the record by the sum of the daily payment value of all records within the pool.

4. The method of claim 1, wherein generating the pool table comprises:
receiving a first data file comprising a first set of records, wherein each record of the first set of records includes the loan identifier, the amount identifier and the investor identifier;
receiving a second data file comprising a second set of records, wherein each record of the second set of records includes the investor identifier and an account identifier;
generating a key table based on the first data file and second data file; and
generating the pool table based in part on the key table.

5. The method of claim 4, wherein generating the pool table further comprises:
receiving a third data file comprising a third set of records, wherein each record of the third set of records includes the loan identifier, the amount identifier, the pool identifier, and one or more of the investor identifier and the account identifier; and
merging the third data file with the key table to form the pool table.

6. The method of claim 5, further comprising:
detecting an error while generating the key table or merging the third data file with the key table; and
in response to detecting the error, entering a quarantine state.

7. The method of claim 6, wherein entering the quarantine state comprises:
storing the pool in a quarantine database;
generating an alert indicating the pool is in the quarantine database; and
displaying the alert.

8. The method of claim 6, wherein detecting the error comprises:
comparing the amount identifier value for each record within the pool to the amount identifier value for each record within the first data file and the third data file.

9. The method of claim 6, wherein detecting the error comprises:
identifying a record within the pool wherein the account identifier is null, and the investor identifier is null.

10. A system comprising:
one or more processors configured to:
generate a pool table, the pool table comprising one or more pools each comprising a set of records comprising a loan identifier, account identifier, investor identifier, pool identifier, and amount identifier; and
for each pool of the one or more pools:
determine an unallocated value by summing each amount identifier within the pool that has a null loan identifier;
compare the unallocated value against a pro rata threshold;
in response to determining the unallocated value exceeds the pro rata threshold;
for each record, generate a credit pro rata value and allocating the credit pro rata value to each amount identifier within the pool; and
in response to determining the unallocated value is less than or equal to the pro rata threshold, for each record, generate a debit pro rata value and allocating the debit pro rata value to each amount identifier value within the pool.

11. The system of claim 10, wherein each record of the set of records further comprises an unpaid principal value, and wherein generating the credit pro rata value for each record comprises dividing unpaid principal value of the record by the sum of the unpaid principal values of all records within the pool.

12. The system of claim 10, wherein each record of the set of records further comprises a daily payment value, and wherein generating the debit pro rata value for each record comprises dividing the daily payment value of the record by the sum of the daily payment value of all records within the pool.

13. The system of claim 10, wherein generating each pool, by the one or more processors, comprises:
receiving a first data file comprising a first set of records, wherein each record of the first set of records includes the loan identifier, the amount identifier and the investor identifier;
receiving a second data file comprising a second set of records, wherein each record of the second set of records includes the investor identifier and an account identifier;
generating a key table based on the first data file and second data file; and
generating the pool based in part on the key table.

14. The system of claim 13, wherein generating the pool, by the one or more processors, further comprises:
receiving a third data file comprising a third set of records, wherein each record of the third set of records includes the loan identifier, the amount identifier, the pool identifier, and one or more of the investor identifier and the account identifier; and
merging the third data file with the key table to form the pool.

15. The system of claim 14, wherein the one or more processors are further configured to:
detect an error while generating the key table or merging the third data file with the key table; and
in response to detecting the error, enter a quarantine state.

16. A non-transitory computer readable medium comprising instructions that, when executed by one or more processors, cause the one or more processors to:
generate a pool table comprising one or more pools each comprising a set of records comprising a loan identifier, account identifier, investor identifier, pool identifier, and amount identifier; and
for each pool of the one or more pools:
determine an unallocated value by summing each amount identifier within the pool that has a null loan identifier;
compare the unallocated value against a pro rata threshold;
in response to determining the unallocated value exceeds the pro rata threshold, for each record, generate a credit pro rata value and allocating the credit pro rata value to each amount identifier within the pool; and
in response to determining the unallocated value is less than or equal to the pro rata threshold, for each record, generate a debit pro rata value and allocating the debit pro rata value to each amount identifier value within the pool.

17. The non-transitory computer readable medium of claim 16, wherein each record of the set of records further comprises an unpaid principal value, and wherein generating the debit pro rata value for each record comprises dividing unpaid principal value of the record by the sum of the unpaid principal values of all records within the pool.

18. The non-transitory computer readable medium of claim 16, wherein each record of the set of records further comprises a daily payment value, and wherein generating the debit pro rata value for each record comprises dividing the daily payment value of the record by the sum of the daily payment value of all records within the pool.

19. The non-transitory computer readable medium of claim 16, wherein generating each pool, by the one or more processors, comprises:
receiving a first data file comprising a first set of records, wherein each record of the first set of records includes the loan identifier, the amount identifier and the investor identifier;
receiving a second data file comprising a second set of records, wherein each record of the second set of records includes the investor identifier and an account identifier;
generating a key table based on the first data file and second data file; and
generating the pool table based in part on the key table.

20. The non-transitory computer readable medium of claim 19, wherein generating the pool, by the one or more processors, further comprises:
receiving a third data file comprising a third set of records, wherein each record of the third set of records includes the loan identifier, the amount identifier, the pool identifier, and one or more of the investor identifier and the account identifier; and
merging the third data file with the key table to form the pool.
